(19) United States
(12) Patent Application Publication
(10) Pub. No.: US 2011/0202603 A1
(43) Pub. Date: Aug. 18, 2011

(54) METHOD AND APPARATUS FOR PROVIDING OBJECT BASED MEDIA MIXING

(75) Inventors: Sujeet Shyamsundar Mate, Tampere (FI); Antti Eronen, Tampere (FI); Juha Ojanpera, Nokia (FI)

(73) Assignee: Nokia Corporation

(21) Appl. No.: 12/704,844

(22) Filed: Feb. 12, 2010

(51) Int. Cl. G06F 15/16

(52) U.S. Cl. 709/205; 709/217

(57) ABSTRACT

An apparatus for providing object based media mixing may include at least one processor and at least one memory including computer program code. The at least one memory and the computer program code may be configured to, with the at least one processor, cause the apparatus to perform at least receiving an indication of shared content to be provided to a plurality of group members, receiving a selection of a region of interest within the shared content, receiving social interaction media associated with at least one of the group members, and mixing the shared content with the social interaction media to provide mixed content. The mixed content may be dynamically modified to avoid overlaying the social interaction media over the region of interest. A corresponding method and computer program product are also provided.

### TECHNOLOGICAL FIELD

Embodiments of the present invention relate generally to content sharing technology and, more particularly, relate to a method and apparatus for providing object based media mixing.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the sharing of information between multiple devices and potentially between multiple users. In this regard, given the ability for modern electronic devices to create and modify content, and also to distribute or share content, it is not uncommon for users of such devices to become prolific users and producers of media content. Networks and services have been developed to enable users to move created content to various points within the networks or experience content at various points within the networks.

Various applications and software have also been developed and continue to be developed in order to give the users robust capabilities to perform tasks, communicate, obtain information or services, entertain themselves, etc. in either fixed or mobile environments. Given the robust capabilities of mobile electronic devices and the relatively small size of such devices, it is becoming increasingly common for individuals to keep mobile electronic devices on or near their person on a nearly continuous basis. Moreover, because such devices are useful for work, play, leisure, entertainment, and other purposes, many users also interact with their devices on a frequent basis. Accordingly, whether interaction occurs via a mobile electronic device or a fixed electronic device (e.g., a personal computer (PC)), more and more people are interacting with friends, colleagues and acquaintances via online networks. This trend has led to the rise of a number of social networking applications that span the entire spectrum of human interaction from purely professional to purely leisure activities and everything in between.

Users of social networking applications often use the social network as a mechanism by which to distribute content to others. Moreover, the concept of social television (TV) has been developed to enable sets of other users, friends, or colleagues to meet in a virtual shared space and watch TV or other video content while also being able to interact socially. The social interaction aspect often takes the form of some form of communication that is added to or over the video content (e.g., dubbing or subtitles). However, in some cases, the social interaction aspect may interfere with or otherwise obstruct the viewing of the video content. Thus, it may be desirable to develop yet further mechanisms by which to enable access to content in a social environment.

### BRIEF SUMMARY

A method, apparatus and computer program product are therefore provided for enabling the provision of object based media mixing. In this regard, for example, some embodiments of the present invention may enable a user selected object or region of interest within viewed content to be tracked along with visual overlay regions associated with social interaction media so that one may not obstruct a view of the other. Furthermore, some embodiments may provide for an ability to attach some form of overlaid material to the selected object or region of interest itself to further customize display of the viewed content.

In one example embodiment, a method of providing object based media mixing is provided. The method may include receiving an indication of shared content to be provided to a plurality of group members, receiving a selection of a region of interest within the shared content, receiving social interaction media associated with at least one of the group members, and mixing the shared content with the social interaction media to provide mixed content. The mixed content may be dynamically modified to avoid overlaying the social interaction media over the region of interest.

In another example embodiment, a computer program product for providing object based media mixing is provided. The computer program product includes at least one computer-readable storage medium having computer-executable program code instructions stored therein. The computer-executable program code instructions may include program code instructions for receiving an indication of shared content to be provided to a plurality of group members, receiving a selection of a region of interest within the shared content, receiving social interaction media associated with at least one of the group members, and mixing the shared content with the social interaction media to provide mixed content. The mixed content may be dynamically modified to avoid overlaying the social interaction media over the region of interest.

In another example embodiment, an apparatus for providing object based media mixing is provided. The apparatus may include at least one processor and at least one memory including computer program code. The at least one memory and the computer program code may be configured to, with the at least one processor, cause the apparatus to perform at least receiving an indication of shared content to be provided to a plurality of group members, receiving a selection of a region of interest within the shared content, receiving social interaction media associated with at least one of the group members, and mixing the shared content with the social interaction media to provide mixed content. The mixed content may be dynamically modified to avoid overlaying the social interaction media over the region of interest.

Embodiments of the invention may provide a method, apparatus and computer program product for employment in network based content sharing environments. As a result, for example, individual device users may enjoy improved capabilities with respect to sharing content with a selected group of other device users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a communication system according to an example embodiment of the present invention;

FIG. 2 is a schematic block diagram of an apparatus for providing object based media mixing according to an example embodiment of the present invention;

FIG. 3 illustrates a sample display view of mixed content according to an example embodiment of the present invention;

FIG. 4 illustrates a sample display view of mixed content showing movement of social interaction media to avoid overlap with a region of interest according to an example embodiment of the present invention;

FIG. 5 illustrates a block diagram pertaining to activities associated with group formation and operation according to an example embodiment of the present invention;

FIG. 6 illustrates example protocols that may be employed for control channel and transport stacks and for media session and transport stacks according to an example embodiment of the present invention; and

FIG. 7 is a block diagram according to an example method for providing object based media mixing according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

Electronic devices have been rapidly developing in relation to their communication and content sharing capabilities. As the capabilities of such devices have increased, applications and services have grown to leverage the capabilities to provide increased utility and improved experience for users. Social networks and various services and functionalities supporting social networks are examples of mechanisms developed to leverage device and network capabilities to provide users with the ability to communicate with each other while experiencing shared content. The shared content may be video and/or audio content that is broadcast from another source or provided by a member of a social network group for consumption by other group members. Meanwhile, while experiencing the shared content together, various group members may discuss the content or other topics by providing text, audio and/or video commentary (e.g., in the form of social interaction media) to be overlaid over the shared content. However, in some cases, the shared content may be obstructed by overlaid video, commentary, images, or other material.

Accordingly, some embodiments of the present invention may provide for a mechanism by which to provide for dynamic control over social interaction media to move such media to avoid overlaying the social interaction media over important portions of the content being overlaid. For example, a user may select one or more objects or regions that are not to be obstructed. The corresponding objects or regions may then be tracked such that if a position of the objects or regions moves to a portion of the display that would otherwise be obstructed by social interaction media, the social interaction media may be moved to avoid the obstruction. Some embodiments may also enable users to attach specific content (e.g., a graphic, video or image) to an object or region of interest to augment, highlight or otherwise modify the corresponding object or region of interest. Thus, users will be provided with improved capabilities for personalizing and satisfactorily experiencing content in a social environment.

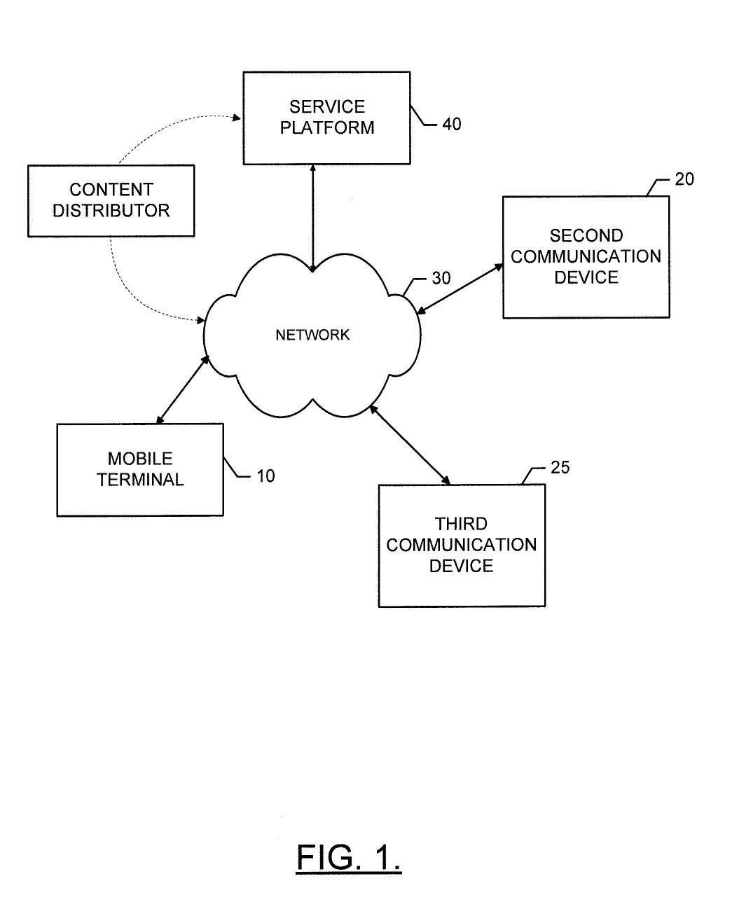

FIG. 1 illustrates a generic system diagram in which a device such as a mobile terminal 10, which may benefit from embodiments of the present invention, is shown in an example communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information. Furthermore, in some cases, the mobile terminal 10 may be in communication with the second communication device 20 (e.g., a PC or another mobile terminal) and one or more additional communication devices (e.g., third communication device 25), which may also be either mobile or fixed communication devices.

The mobile terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video player, radio, global positioning system (GPS) devices, or any combination of the aforementioned, and other types of voice and text communications devices. The second and third communication devices 20 and 25 may be any of the above listed mobile communication devices or an example of a fixed communication device such as a PC or other computing device or communication terminal having a relatively fixed location and wired or wireless access to the network 30.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. Alternatively, such devices may include communication interfaces supporting landline based or wired communication with the network 30. In turn, other devices such as processing elements (e.g., personal computers, server computers or the like) may be coupled to the mobile terminal 10 and/or the second and third communication devices 20 and 25 via the network 30. By directly or indirectly connecting the mobile terminal 10 and/or the second communication device 20 and other devices to the network 30, the mobile terminal 10 and/or the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, regardless of the form of instantiation of the devices involved, embodiments of the present invention may relate to the provision of access to content within the context of a social network including a defined group of users and/or the devices of the users. The group may be predefined based on any of a number of ways that a particular group may be formed. In this regard, for example, invited members may accept invitations to join the group, applications may be submitted and accepted applicants may become group members, or a group membership manager may define a set of users to be members of a group. Thus, for example, group members could be part of a social network or may be associated with a particular service such as a service hosted by or associated with the service platform 40. Accordingly, it should be appreciated that, although FIG. 1 shows three example devices capable of communication, some embodiments may include groups like social networks with the potential for many more group members and corresponding devices. Thus, FIG. 1 should not be seen as being limiting in this regard.

In an example embodiment, the service platform 40 may be a device or node such as a server or other processing circuitry. The service platform 40 may have any number of functions or associations with various services. As such, for example, the service platform 40 may be a platform such as a dedicated server, backend server, or server bank associated with a particular information source, function or service. As such, the service platform 40 may represent one or more of a plurality of different services or information sources. The functionality of the service platform 40 may be provided by hardware and/or software components configured to operate in accordance with known techniques for the provision of information to users of communication devices, except as modified as described herein.

In an example embodiment, the service platform 40 may provide, among other things, content management, content sharing, content acquisition and other services related to communication and media content. Nokia's Ovi suite is an example of a service provision mechanism that may be associated with the service platform 40. In some cases, the service platform 40 may include, be associated with, or otherwise be functional in connection with a content distributor 42. However, the content distributor 42 could alternatively be embodied at one or more of the mobile terminal 10 and/or the second and third communication devices 20 and 25, or even at some other device within the network. As such, for example, in some cases the network 30 could be an ad hoc, peer-to-peer (P2P) network in which the content distributor 42 is embodied in at least one of the devices forming the P2P network. Thus, although the content distributor 42 is shown as a separate entity in FIG. 1, it should be appreciated that the content distributor 42 could be associated directly with or even instantiated at any of the other devices shown in FIG. 1 in various alternative embodiments. In any case, as will be discussed in greater detail below, the content distributor 42 according to one example may provide content in the form of television broadcast or other video/audio content for consumption by group members. In some cases, the content may be content originating from a source external to the group, but in other cases, one group member may select content to be shared with other members of the group and provide such content to the other members or have such content streamed from the content distributor 42.

In an example embodiment, the service platform 40 may be associated with the provision of functionality and services associated with social networking. Thus, for example, the service platform 40 may include functionality associated with enabling group members to share social interaction media with each other. As such, the service platform 40 may act as or otherwise include a social TV server or another social networking server for providing the social interaction media to group members based on individual participant media submissions from various ones of the group members. The social interaction media may include text, audio, graphics, images, video and/or the like that may be overlaid over other content being shared among group members (e.g., shared content). Thus, in some cases, such as is sometimes the case with social TV, the social interaction media may be commentary regarding the shared content.

In some cases, the content distributor 42 may provide content to the service platform 40 and the service platform 40 may integrate the content provided thereto by the content distributor 42 with social interaction content provided from the group members (e.g., the mobile terminal 10 and/or the second and third communication devices 20 and 25). The service platform 40 may employ an apparatus for object based media mixing according to an example embodiment to thereafter provide mixed content to the group members. Alternatively, the service platform 40 may provide the social interaction media to the group members and the content distributor 42 may separately provide content for viewing by the group members and the individual devices of the group members may employ an apparatus for object based media mixing according to an example embodiment to thereafter provide mixed content to the group members.

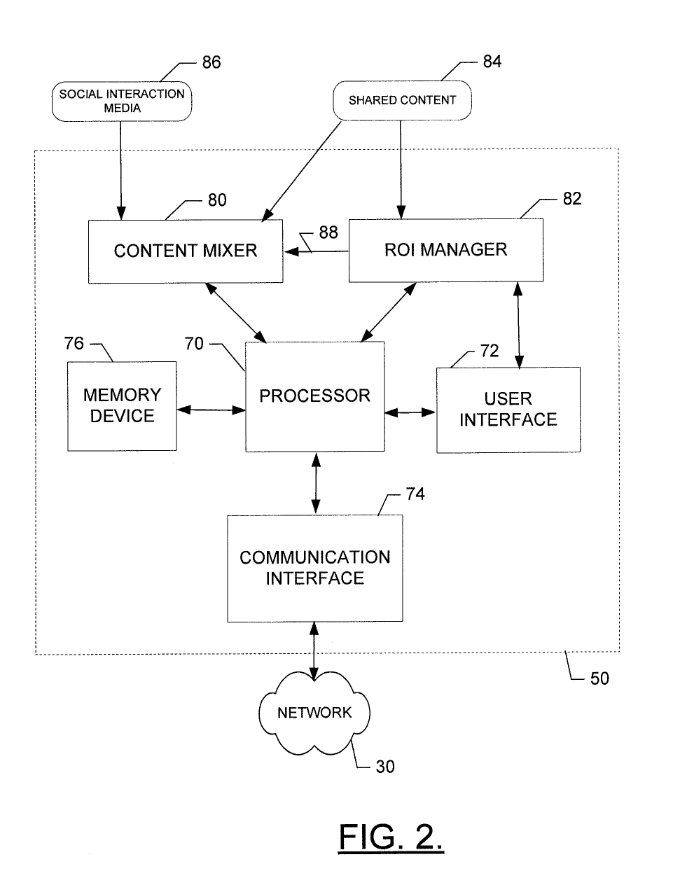

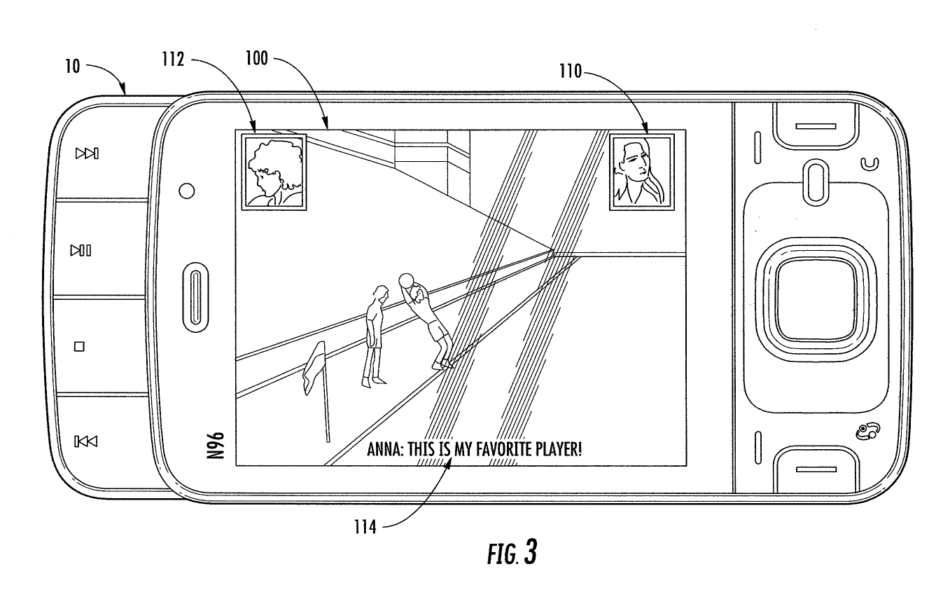

FIG. 2 illustrates a schematic block diagram of an apparatus for enabling the provision of object based media mixing according to an example embodiment of the present invention. An example embodiment of the invention will now be described with reference to FIG. 2, in which certain elements of an apparatus 50 for providing object based media mixing are displayed. The apparatus 50 of FIG. 2 may be employed, for example, on a communication device (e.g., the mobile terminal 10 and/or the second or third communication devices 20 or 25) or a variety of other devices, both mobile and fixed (such as, for example, the service platform 40 or any of the devices listed above). Alternatively, embodiments may be employed on a combination of devices. Accordingly, some embodiments of the present invention may be embodied wholly at a single device (e.g., the mobile terminal 10 or the service platform 40) or by devices in a client/server relationship. Furthermore, it should be noted that the devices or elements described below may not be mandatory and thus some may be omitted in certain embodiments.

Referring now to FIG. 2, an apparatus 50 for providing object based media mixing is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates or other structure configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70. In some embodiments, the memory device 76 may also or alternatively store content items (e.g., media content, documents, chat content, message data, videos, music, pictures and/or the like).

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. In some cases, the processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, provided remotely (e.g., from the mobile terminal 10 or another device) or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a content mixer 80 and a region of interest (ROI) manager 82. The content mixer 80 and the ROI manager 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content mixer 80 and the ROI manager 82, respectively, as described below. Thus, in examples in which software is employed, a device or circuitry (e.g., the processor 70 in one example) executing the software forms the structure associated with such means.

In an example embodiment, the content mixer 80 may be configured to combine at least two data streams into a single combined content item capable of rendering at an output device such as a display and/or speakers or other user interface components. In some cases, the content mixer 80 may be configured to overlay social interaction media 86 over audio and/or video content from the content distributor 42. As such, the content mixer 80 may combine signaling associated with the audio and/or video content, which may be content intended for sharing amongst members of a group (e.g., shared content 84), with graphics, audio, video, text, images and/or the like that may be provided by one or more group members for sharing with other group members as social interaction media 86. The combined data output from the content mixer 80 may then be provided for display and/or audio rendering such that, for example, video, audio, images, text or graphics associated with the social interaction media 86 are overlaid over the video content of the shared content 84 and sound associated with the social interaction media 86 is dubbed into the audio of the shared content 84. In an example embodiment, the output of the content mixer 80 may also include augmentations or other modifications associated with ROI data 88 generated by the ROI manager 82 as described in greater detail below. As such, for example, the content mixer 80 may be configured to provide for display feature management based on a position of a ROI (as determined by the ROI data) relative to social interaction media content.

The ROI manager 82 may be configured to, perhaps among other things, provide for designation of a ROI, provide tracking of the ROI, and/or provide for augmentation of the ROI. Thus, for example, the ROI manager 82 is configured to enable a user to select a ROI, which may be any identifiable person, place or thing in an image or video frame. In an example embodiment, the user may be enabled to utilize the user interface 72 to select an object or item to act as the ROI. For example, the user may select a particular object or utilize a cursor, touch screen, gaze tracking, click and drag operation or other functionality to define a region including an object that is to act as the ROI.

In response to selection of a ROI, the ROI manager 82 may then track (or receive reports from another entity tracking the ROI) the ROI as the ROI moves to various positions on a display screen. In an example embodiment, responsive to tracking of the ROI, the ROI manager 82 is configured to generate tracking information or reports as the ROI data 88, which is descriptive of the position of the ROI in any particular image or frame of a video sequence. As such, the ROI manager 82 may be configured to provide the ROI data 88 to the content mixer 80 for use by the content mixer 80 in generating mixed content for display at the user interface 72. The mixed content may include the shared content 84 with overlay data provided based on the social interaction media 86. However, positions of objects or content items associated with the social interaction media 86 may be altered by the content mixer 80 based on the ROI data 88. In this regard, for example, the content mixer 80 may be configured to compare positions of content items associated with the social interaction media 86 with a position of the ROI and move the content items associated with the social interaction media 86 to prevent the social interaction media 86 from obscuring a view of the ROI (or at least reduce the amount of obscuring in cases where some obscuring is not avoidable). In other words, the content mixer 80 of some examples is configured to move content items associated with social interaction media if a position of the ROI moves to create overlap (or moves within a threshold distance of creating an overlap) with a content item associated with the social interaction media 86. The moved content items are typically moved to another location where the overlap would not currently occur.

In some alternative embodiments, rather than avoiding obstruction of an ROI by moving social interaction media that overlaps therewith, the content mixer 80 may be configured to decrease visibility of the social interaction media 86, when an overlap is perceived. As such, for example, avoidance of an obstructing overlap condition may in some cases be remedied by increasing the transparency of the social interaction media 86 or decreasing the size of a media window of the social interaction media. Other modifications may also be performed. Moreover, in some cases, rather than decreasing visibility of social media to avoid obstruction, the content mixer 80 may actually be configured to increase social interaction media 86 visibility. For example, darker colors over light portions, lighter colors over dark portions or otherwise more contrasting colors relative to the colors presented in the shared content 84 may be utilized for making social interaction media 86 appear more visible.

As indicated above, in some embodiments, the ROI manager 82 may be further configured to provide for augmentation of the ROI. In example embodiments where this feature is employed, the ROI manager 82 may be configured to enable a user to select a graphic, video or image to overlay the ROI. Thus, for example, the ROI could effectively be replaced with the corresponding graphic, video or image. As such, when the ROI moves within the shared content 84, the graphic, video or image that was selected to overlay the ROI may move accordingly.

In an example embodiment, the user may be enabled to select or otherwise define the ROI, as indicated above, and the user may thereafter be enabled to select a content item (e.g., a graphic, video clip or image) to be overlaid over the ROI as an ROI overlay. In some examples, the graphic, video or image that is selected to overlay the ROI may be automatically resized based on a size of the ROI. For example, if the ROI is selected to correspond to a ball when the shared content 84 relates to a sporting event, the size of the ball may change dependent upon the view of the particular shot of the sports event. In this regard, for wide angle shots, the ball may be small and therefore the ROI may also be small. However, for close up shots, the ball may be larger and thus the ROI may also be larger. In some embodiments, the size of the ROI overlay may be constant regardless of the size of the ROI, but in other cases, the ROI overlay may be resized to fit the size of the ROI for any given frame of the shared content 84.

The definition of an ROI overlay may be implemented in connection with embodiments that track the ROI to avoid obstruction of the ROI by social interaction media as well. However, ROI overlays could also be practiced independent of social interaction media avoidance. Furthermore, in some cases, context awareness may be implemented such that the ROI overlay may be automatically generated based on the current context. For example, if the current date is a birthday of one of the participants in a session, an object may selected to be annotated with the name of the participant having the birthday and some graphic such as a birthday cake or greeting may replace the selected object.

FIG. 3 illustrates a sample display view of mixed content according to an example embodiment of the present invention. In this regard, FIG. 3 shows an example of a mobile communication device (e.g., mobile terminal 10) that may be used in connection with an example embodiment. The mobile terminal 10 includes a display 100 that is presenting shared content 84 in the form of a sporting event. The mobile terminal 10 is also displaying various content items associated with social interaction media 86. In this example, the social interaction media 86 includes a media window 110 of a first group member and a media window 112 of a second group member participating in a chat session while watching the shared content 84. The media windows 110 and 112 may be real time video feeds in some cases, but may also be static images stored in association with the corresponding contact information of each respective group member in other embodiments. Although two group members are shown in this example, any number of group members could be shown. Moreover, in some embodiments, media window of a group member may only be shown when a corresponding one of the group members provides social interaction media 86 or a limited number of media windows of most active or most recently active members may be provided. However, in alternative embodiments, media windows of present group members may be shown. Thus, any number of media windows for present group members (or actively chatting group members) may be provided. The social interaction media 86 of this example also includes chat text 114. The chat text 114 indicates an identity of the provider of the chat text 114 and the content itself In some cases, chat content may be provided by users that do not wish to be seen or do not have the capability to stream real-time video of themselves to the group. The social interaction media 86 is provided as visual (and perhaps also audio) overlay content that is presented over the shared content 84. In some cases, the visual overlay content may have some degree of transparency, as in the case of the chat text 114. However, in other cases, the visual overlay content may not be transparent, as in the case of the media windows 110 and 112.

In the example of FIG. 3, the shared content 84 may be provided to the content mixer 80 and the ROI manager 82 and the ROI manager 82 may provide an indication of the ROI, movement of the ROI, and ROI overlay information as ROI data 88 as appropriate. The content mixer 80 may also receive information descriptive of the social interaction media 86 and present the social interaction media 86 as an overlay to the shared content 84 shown on the display 100 as shown in FIG. 3.

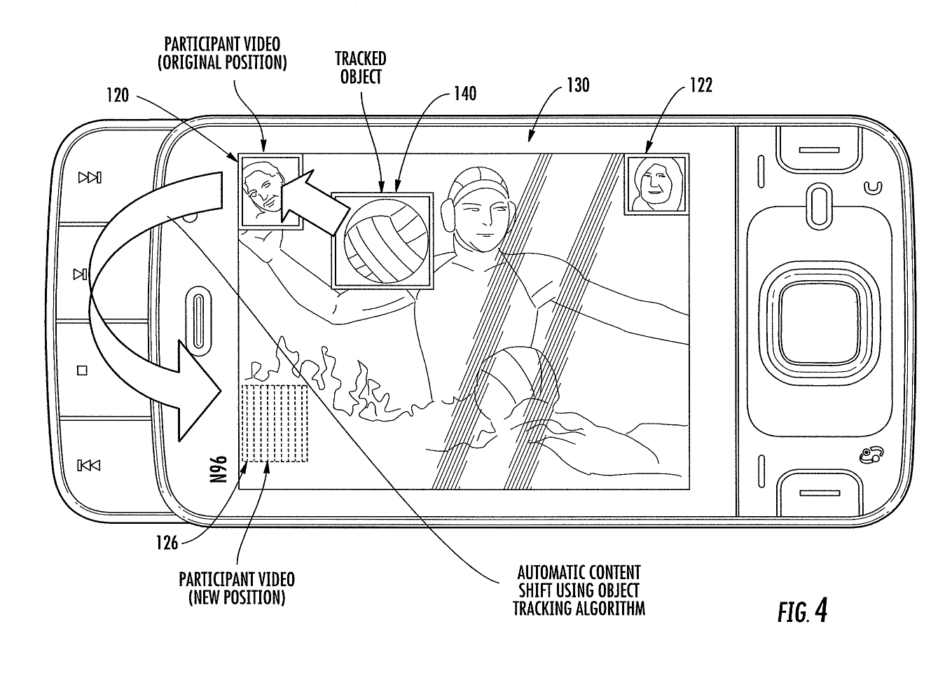

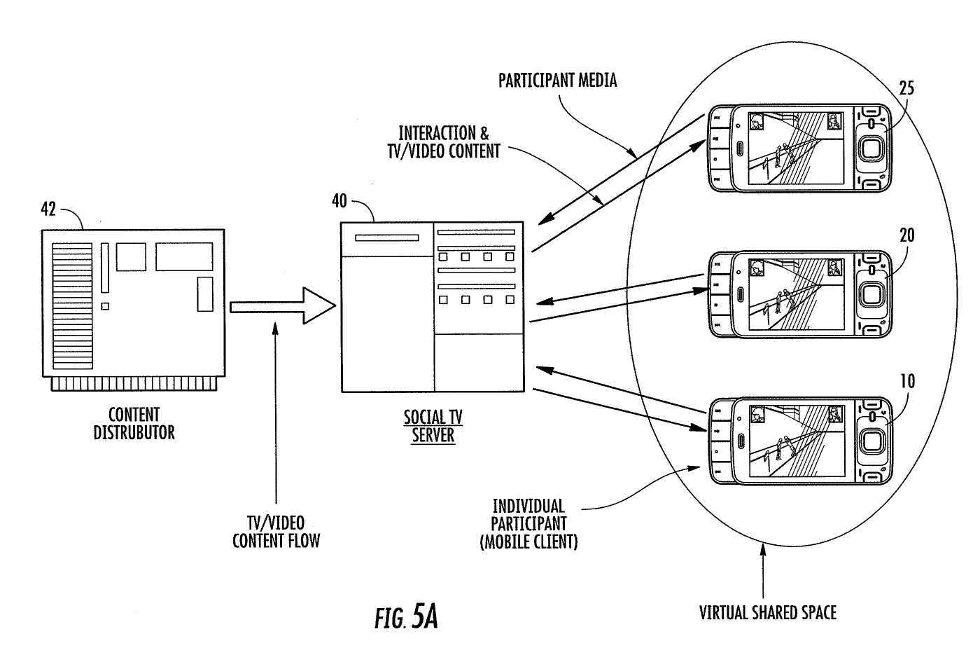

FIG. 4 illustrates a sample display view of mixed content showing movement of social interaction media to avoid overlap with the ROI according to an example embodiment of the present invention. In FIG. 4, a media window 120 of a first session participant is shown in the upper left corner of a display view 130 of the shared content 84. A media window 122 of a second session participant is shown in the upper right corner of the display view 130. In this example, a ball has been selected as an object to be tracked as the ROI 140. In the example of FIG. 4, as the ball is shot toward the net and rises up to the upper left corner of the display view 130, the overlay of the media window 120 would tend to obstruct the view of the ROI 140. As the ROI 140 moves to a position where obstruction may begin, the content mixer 80 may move the media window 120 to a new position 126. In some embodiments, the media window 120 may remain at the new position 126 until a conflict with the ROI 140 develops (e.g., the ROI 140 moves to a position where it would be obstructed by the media window 120 in the new position 126). However, in alternative embodiments, the media window 120 may be returned to its initial position after a time delay or in response to the ROI 140 vacating the initial position.

Accordingly, as can be seen from FIG. 4, an object tracking algorithm or other object tracking device or mechanism may be employed to track an object (e.g., associated with the ROI 140). When the tracked object would otherwise be obstructed by social interaction media, the social interaction media may be automatically repositioned to avoid obstruction. In some embodiments, the content mixer 80 may be configured to perform social interaction media repositioning in response to a boundary of a content item associated with the social interaction media overlapping or coming into contact with a boundary of the ROI 140. However, other triggers for repositioning could alternatively be employed. For example, one or more of the content items associated with the social interaction media and the ROI 140 may have buffer zones having predetermined sizes positioned around the actual boundaries of such objects so that when a buffer zone of an object encounters another object or buffer zone, the content item associated with the social interaction media is triggered to be repositioned. In any case, repositioning of the social interaction media is typically accomplished to avoid overlap of a visual overlay object associated with the social interaction media and the ROI 140.

As indicated above, the apparatus 50 may be employed at a network device (e.g., the service platform 40) or at a communication device (e.g., the mobile terminal 10). Accordingly, it should be appreciated that the mixing of content according to example embodiments could be accomplished either at the device displaying the content (such as when the mobile terminal 10 includes the apparatus 50) or at a device serving content to the device displaying the content (such as when the service platform 40 includes the apparatus 50). Accordingly, for example, if the apparatus 50 is employed at the device serving content to the device displaying the content, the social interaction media 86 and the shared content 84 could be provided in a single stream of data (e.g., along with the ROI data 88). However, if the apparatus 50 is employed at the device displaying the content, the social interaction media 86 and the shared content 84 could be provided in a separate streams of data (e.g., with the ROI data 88 accompanying the shared content 84). In still another alternative embodiment, portions of the apparatus 50 may be split between multiple devices (as discussed above), and thus the content mixer 80 may be embodied at the device displaying the content (e.g., the mobile terminal 10), while the ROI manager 82 is embodied at the device serving content to the device displaying the content (e.g., at the service platform 40). In this example, the shared content 84 with the ROI data 88 may be provided in one stream and the social interaction media 86 may be provided in a separate stream. Regardless of the mechanism by which the streams of data are received and where each respective device is physically located, the content mixer 80 may be configured to modify media mixing (e.g., modify the content to be displayed) to provide an avoidance of overlap between an ROI and visual overlay data of social interaction media.

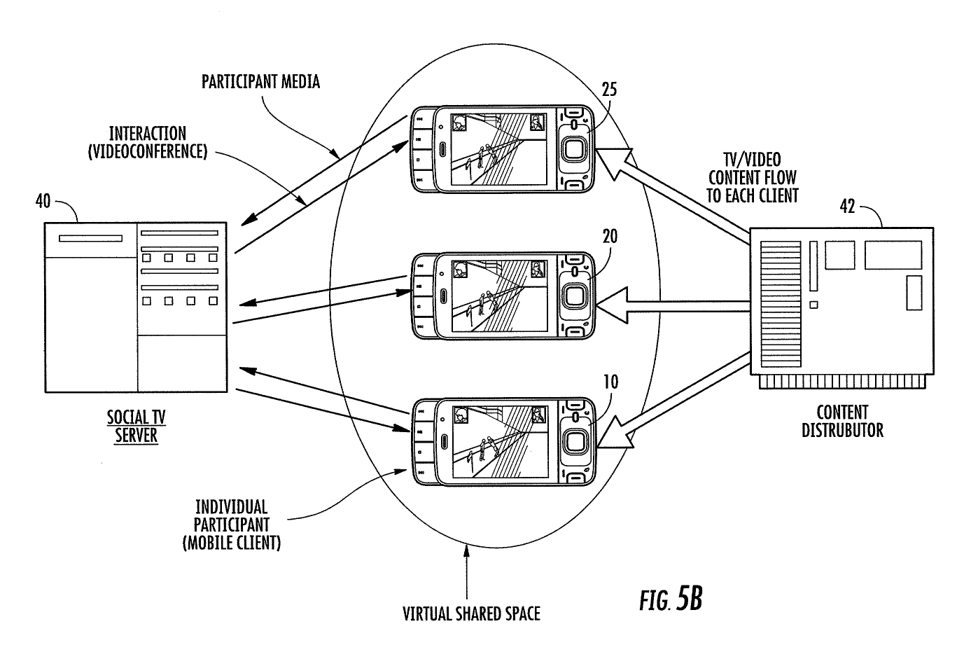

FIG. 5, which includes FIGS. 5A and 5B, shows two different mixing possibilities in accordance with example embodiments of the present invention. Although FIG. 5 is discussed in connection with social TV, it should be appreciated that embodiments of the present invention could be practiced in connection with other types of shared content as well. FIG. 5A illustrates centralized mixing in connection with social TV where shared content is mixed with social interaction media at a social TV server (e.g., the service platform 40) and then provided to participant client devices in a virtual shared space. As shown in FIG. 5A, the interaction media streams (e.g., participant media) may be provided to the service platform 40 so that the service platform 40 can aggregate social interaction media for provision to all group members or client devices (e.g., the mobile terminal 10 and the first and second communication devices 20 and 25). The service platform 40 may also receive indications from one or more of the client devices to designate one or more objects or other ROIs to be tracked (e.g., via a control channel). The corresponding objects may then be tracked (e.g., by the ROI manager 82) and social interaction media may be mixed with shared content (e.g., from the content distributor 42 or from one of the client devices) to provide mixed content based on ROI tracking information to provide for modification of the mixed content to avoid overlap of visual overlays associated with the social interaction media with an ROI. The mixed content (modified or unmodified) may then be provided as a composite stream to each participant client device.

FIG. 5B illustrates an embodiment with end-point mixing in which the shared content is provided directly to the participant clients and the social interaction media is also provided directly to the participant clients so that content may be mixed at the participant clients. Particularly in end-point mixing, each user (or at least multiple users) may select a different ROI and the system may operate to provide each respective user with display information mixed based on the selected ROI and its relationship to social interaction media. However, in some cases, the central mixing embodiment could be implemented to provide each respective user with differing ROI data based on the ROI selected by each respective user. In alternative embodiments, an ROI may be selected by a user and shared with all other users or a selected portion of the other users. Moreover, in some cases, multiple ROI selections may be offered as options and the group members may vote to select a single ROI to be tracked for object based media mixing according to an example embodiment.

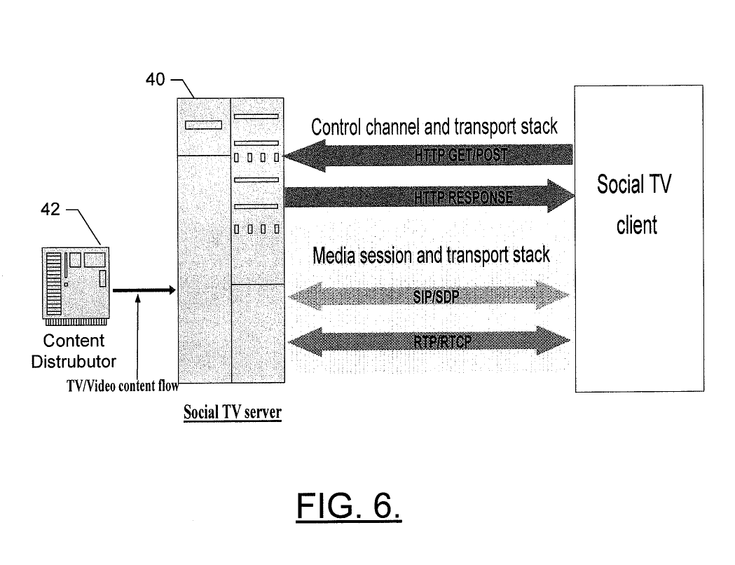

In an example embodiment, signaling of user selections (e.g., selecting an ROI) may be provided via a session control channel as indicated above. Any suitable protocols may be employed for control channel and transport stacks and for media session and transport stacks (e.g., session initiation protocol (SIP), session description protocol (SDP), real-time transport protocol (RTP), real-time transport control protocol (RTCP), HTTP, short message service (SMS), and/or the like, as shown in FIG. 6.

In addition to signaling ROI data and mixed content as described above, in some cases users may be enabled to define a ROI mask corresponding to an area of the display that is considered interesting and not to be overlaid, while other portions may be designated as background, which can be overlaid. When presenting mixed content or even when moving items to avoid overlaying a moving ROI as indicated above, the ROI mask area may be exempt from being a potential location to which social interaction media may be moved.

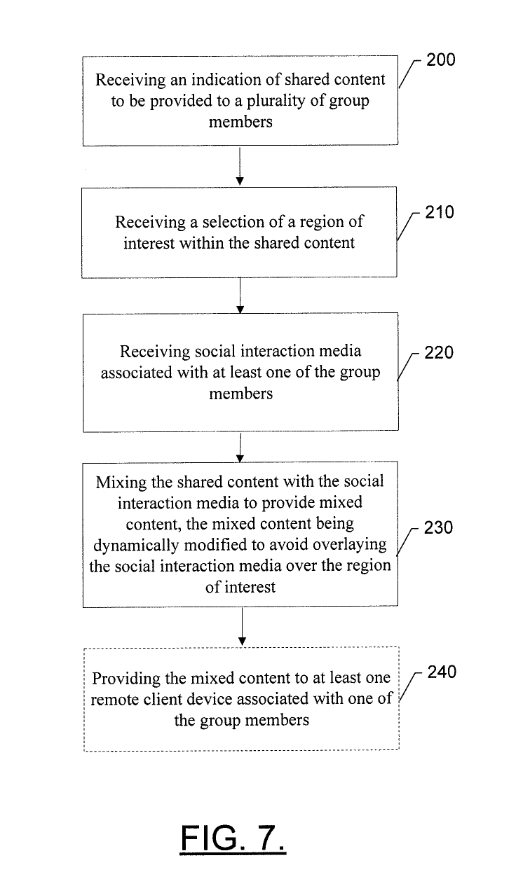

FIG. 7 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 7, may include receiving an indication of shared content to be provided to a plurality of group members at operation 200 and receiving a selection of a region of interest within the shared content at operation 210. The method may further include receiving social interaction media associated with at least one of the group members at operation 220 and mixing the shared content with the social interaction media to provide mixed content at operation 230. The mixed content may be dynamically modified to avoid overlaying the social interaction media over the region of interest.

In some embodiments, certain ones of the operations above may be modified or further amplified as described below. Moreover, in some situations, the operations described above may be augmented with additional optional operations (an example of which is shown in FIG. 7 in dashed lines). It should be appreciated that each of the modifications, augmentations or amplifications below may be included with the operations above either alone or in combination with any others among the features described herein. In an example embodiment, the method may further include providing the mixed content to at least one remote client device associated with one of the group members at operation 240. In an alternative case, the indication of shared content and the social interaction media may be received via different data streams at the device doing the mixing. In some cases, receiving the indication of shared content and receiving the social interaction media may include receiving the indication of shared content and the social interaction media via different data streams. In an example embodiment, receiving the selection of the region of interest may include receiving a region of interest selection from multiple ones of the plurality of group members. Embodiments of the invention may thereafter be practiced to a selected on of the multiple received selections or with respect to multiple ones of the selections. In some embodiments, mixing the shared content with the social media content may include tracking movement of the region of interest and, in response to movement of the region of interest to a position at which a portion of the region of interest overlaps a portion of a content item of the social interaction media, moving a position of the content item from a location at which the portion of the content item does not overlap the portion of the region of interest. In an example case, receiving the selection of the region of interest further may include receiving an indication of content to overlay the region of interest. Furthermore, receiving the indication of content to overlay the region of interest may include receiving the indication based on current context information.

In an example embodiment, an apparatus for performing the method of FIG. 7 above may comprise a processor (e.g., the processor 70) configured to perform some or each of the operations (200-240) described above. The processor may, for example, be configured to perform the operations (200-240) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-240 may comprise, for example, the processor 70, or respective ones of the content mixer 80, the ROI manager 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
receiving an indication of shared content to be provided to a plurality of group members;
receiving a selection of a region of interest within the shared content;
receiving social interaction media associated with at least one of the group members; and
mixing the shared content with the social interaction media to provide mixed content, the mixed content being dynamically modified to avoid overlaying the social interaction media over the region of interest.

2. The apparatus of claim 1, wherein the at least one memory and the computer program code are further configured to, with the at least one processor, further cause the apparatus to provide the mixed content to at least one remote client device associated with one of the group members.

3. The apparatus of claim 1, wherein the at least one memory and the computer program code are further configured to, with the at least one processor, cause the apparatus to receive the indication of shared content and the social interaction media via different data streams.

4. The apparatus of claim 1, wherein the at least one memory and the computer program code are further configured to, with the at least one processor, cause the apparatus to receive region of interest selections from multiple ones of the plurality of group members.

5. The apparatus of claim 1, wherein the at least one memory and the computer program code are further configured to, with the at least one processor, cause the apparatus to mix the shared content with the social media content responsive to tracking movement of the region of interest and, in response to movement of the region of interest to a position at which a portion of the region of interest overlaps a portion of a content item of the social interaction media, moving a position of the content item from a location at which the portion of the content item does not overlap the portion of the region of interest.

6. The apparatus of claim 1, wherein the at least one memory and the computer program code are further configured to, with the at least one processor, cause the apparatus to receive the selection of the region of interest in association with receiving an indication of content to overlay the region of interest.

7. The apparatus of claim 1, wherein the at least one memory and the computer program code are further configured to, with the at least one processor, cause the apparatus to receive the indication of content to overlay the region of interest based on current context information.

8. The apparatus of claim 1, wherein the apparatus is embodied at a mobile terminal.

9. The apparatus of claim 1, wherein the apparatus is embodied at a network service platform.

10. A method comprising:
receiving an indication of shared content to be provided to a plurality of group members;
receiving a selection of a region of interest within the shared content;
receiving social interaction media associated with at least one of the group members; and
mixing the shared content with the social interaction media to provide mixed content, the mixed content being dynamically modified to avoid overlaying the social interaction media over the region of interest.

11. The method of claim 10, further comprising providing the mixed content to at least one remote client device associated with one of the group members.

12. The method of claim 10, wherein receiving the indication of shared content and receiving the social interaction media comprises receiving the indication of shared content and the social interaction media via different data streams.

13. The method of claim 10, wherein receiving the selection of the region of interest comprises receiving a region of interest selection from multiple ones of the plurality of group members.

14. The method of claim 10, wherein mixing the shared content with the social media content comprises tracking movement of the region of interest and, in response to movement of the region of interest to a position at which a portion of the region of interest overlaps a portion of a content item of the social interaction media, moving a position of the content item from a location at which the portion of the content item does not overlap the portion of the region of interest.

15. The method of claim 10, wherein receiving the selection of the region of interest further comprises receiving an indication of content to overlay the region of interest.

16. The method of claim 15, wherein receiving the indication of content to overlay the region of interest comprises receiving the indication based on current context information.

17. A computer program product comprising at least one computer-readable storage medium having computer-executable program code instructions stored therein, the computer-executable program code instructions comprising:
program code instructions for receiving an indication of shared content to be provided to a plurality of group members;
program code instructions for receiving a selection of a region of interest within the shared content;
program code instructions for receiving social interaction media associated with at least one of the group members; and
program code instructions for mixing the shared content with the social interaction media to provide mixed content, the mixed content being dynamically modified to avoid overlaying the social interaction media over the region of interest.

18. The computer program product of claim 17, further comprising program code instructions for providing the mixed content to at least one remote client device associated with one of the group members.

19. The computer program product of claim 17, wherein program code instructions for receiving the indication of shared content and receiving the social interaction media include instructions for receiving the indication of shared content and the social interaction media via different data streams.

20. The computer program product of claim 17, wherein program code instructions for mixing the shared content with the social media content include instructions for tracking movement of the region of interest and, in response to movement of the region of interest to a position at which a portion of the region of interest overlaps a portion of a content item of the social interaction media, moving a position of the content item from a location at which the portion of the content item does not overlap the portion of the region of interest.
